(19) United States
(12) Patent Application Publication
(10) Pub. No.: US 2006/0123421 A1
(43) Pub. Date: Jun. 8, 2006

(54) Streamlining cpu utilization by delaying transactions

(76) Inventor: Charles Zdzislaw Loboz, West Ryde (AU)

Correspondence Address: UNISYS CORPORATION, UNISYS WAY, MAILSTOP E8-114, BLUE BELL, PA, 19424-0001, US

(21) Appl. No.: 10/540,767

(22) PCT Filed: Dec. 27, 2002
(86) PCT No.: PCT/US02/41431

§ 371 Date: Jun. 24, 2005

(51) Int. Cl. G06F 9/46

(52) U.S. Cl. 718/105

(57) ABSTRACT

The present invention provides a method and system for scheduling a transaction request to a central processing unit in a computing system (11), comprising polling at least one central processing unit to determine the current load on the least one central processing unit (10), allocating the transaction request to one the at least one central processing unit (12), or if the current load is above a predetermined threshold, delaying execution of the transaction request for a predetermined delay time (14).

### FIELD OF THE INVENTION

The present invention relates to improvements in central processing unit utilisation in a computing system.

### BACKGROUND OF THE INVENTION

An ongoing issue in processing systems is the goal of making more efficient use of central processing units (CPU's).

Many approaches have been taken to increase the efficiency of CPU utilisation. For example, there are many operating systems which use multiple threads and/or multiple processes to maximise the “responsiveness” of the computing system. In a multiple thread/process systems, a group of threads or processes are generally bound to the same CPU. In this scenario (where more than one thread or process is bound to the same CPU), if one process or thread is not executing for a given reason (e.g. the process is waiting for an input/output operation to complete) then another process or thread can utilise the CPU while the first one is waiting.

This methodology is problematic, since operating systems cannot always schedule a thread or process to execute on a CPU when the previous thread or process is waiting on an external operation to complete. Rather, the operating system will attempt to pre-empt the currently executing thread or process, effectively interrupting the currently running thread or process, and stopping its execution. The operating system will then load the other process or thread into the same CPU, to allow it to execute for a given time. This pre-empting generally occurs after a defined period of time, commonly termed a “time slice”. Time slices vary between different operating systems. For example, the time slice on a multi-processor Microsoft Windows™ system is approximately 15 milliseconds. However, it will be appreciated that the time slice may vary between 15 to 150 milliseconds, depending on specific circumstances. The above examples of a time slice length are provided as examples only, and should be construed as illustrative but not restrictive or definitive.

Overall system performance is degraded, since there is a significant overhead involved in switching or changing between threads or processes.

When one thread is pre-empted to allow another thread to execute, there are a number of steps which must be carried out to complete the “switching” process, each step incurring a certain time and/or resource overhead.

Firstly, the context of the pre-empted thread must be saved. The term “context” will be understood to mean any data set and/or instruction set necessary for the CPU to execute the transaction requested provided by the thread or process. To achieve this, a certain amount of time and resources must be used to transfer data to either cache memory or main memory.

Secondly, the context of the thread to be executed must be loaded into the registers of the CPU. Once again, this process of loading uses a certain amount of time and resources, as data must be loaded from cache and/or main memory to the CPU registers.

Thirdly, if the execution context of the thread to be executed is sufficiently different to that of the pre-empted thread, the instruction cache may be at least partially, if not fully, overwritten. This process uses a significant amount of time. Additionally, the instructions of the originally executing thread must be re-loaded into the instruction cache once it is rescheduled to execute on the same CPU, thereby incurring a significant time penalty.

Lastly, if the data used by the thread to be executed is sufficiently different to that of the pre-empted thread, the data cache may be partially, if not fully, overwritten. The performance penalty is even more significant than in the previous scenario because the data cache cannot be simply overwritten. Rather, any changes made to the data cache must firstly be written back to main memory before any new data can be loaded into the data cache. Thus, a significant time penalty is incurred on “writing back” (the process of transferring data from the date cache into main memory) and subsequently re-loading the data cache.

Therefore, the use of multiple threads and/or multiple processes, and in particular, the use of time slicing, creates a number of disadvantages in a transaction processing system. Whilst an operating system developer may desire the use of time slicing to ensure that every thread or process is given an equal share of CPU time and to maintain the appearance (to the end user) that many processes are executing simultaneously, the associated overhead created by loading and unloading the data associated with each process results in a perceptible performance degradation.

### SUMMARY OF THE INVENTION

In a first aspect, the present invention provides a method of scheduling a transaction request to a central processing unit in a computing system, comprising the steps of,
for a transaction request, polling at least one central processing unit to determine the current load on the at least one central processing unit;
if the current load is below a predetermined threshold, allocating the transaction request to one of the at least one central processing unit,
if the current load is above the predetermined threshold, delaying execution of the transaction request for a predetermined time period.

Preferably, polling continues until the current load drops below the predetermined threshold, at which time the transaction request is allocated.

It will be understood that the computing system may comprise a number of CPU's, all of which may be polled continuously, such that when one of the plurality of CPU's falls below the predetermined threshold, the transaction request is allocated to the one of the plurality of CPU's.

Preferably, the predetermined threshold is achieved when the at least one of a plurality of CPU's becomes idle.

There are two statistics that are of interest in a computing system. The first is total throughput (i.e. how many transaction requests are processed in a given time), and the second is response time (i.e. how much time is required for a transaction request to be executed).

The response time is not as critical a statistic as the total throughput. It is only necessary to ensure that the response time remains within limits that are considered to be reasonable by an end user. For example, a user will not be able to determine whether the transaction processing system has a response time of, say, 20 milliseconds, or a response time of 100 milliseconds. Although one response time is five times slower than the other, a user is not capable of discerning between the two values.

An advantage of the present invention preferably resides in the ability of the method to increase the total number of transactions processed within a given time interval by delaying individual transactions, whilst concurrently managing the delay in a manner such that the response time for an individual transaction is not increased to a point where the delay is perceptible to an end user.

Preferably, the method comprises the further step of polling at defined time intervals to determine the system load.

Preferably, the predetermined time delay is chosen such that an end user cannot determine any perceptible change in response time.

Preferably, the predetermined time delay does not exceed 500 milliseconds. It is generally accepted by a person skilled in the art that a transaction response time should be kept below a value of 1000 milliseconds. Therefore, response times of up to 500 milliseconds are generally acceptable to an end user, in most situations.

Preferably, the predetermined time delay is in the order of one to fifteen time slices. In one embodiment of the invention, the transaction is delayed by a time period that corresponds to a range between one and fifteen time slices. In some operating systems, the time slice may be of the order of 15 milliseconds. However, this value may be varied depending on the type of operating system, the type of computer hardware, or any other appropriate consideration.

In a second aspect, the present invention provides a system for scheduling an incoming transaction to a central processing unit in a computing system, the system comprising:

polling means arranged to, for a transaction request, poll at least once central processing unit to obtain a value for the central processing unit load,
comparison means arranged to, if the current load is below a predetermined threshold, allocate the transaction request to one of the at least one central processing unit,
if the current load is above the predetermined threshold, delay execution of the transaction request for a predetermined time period.
   In a third aspect, the present invention provides a computer program arranged, when loaded on a computing system, to implement a method in accordance with a first aspect of the invention, or any dependant aspect thereof. In a fourth aspect, the present invention provides a computer readable medium providing a computer program in accordance with a third aspect of the invention.

### DETAILED DESCRIPTION OF THE DRAWINGS

An embodiment of the invention will now be described by way of illustration, in which:

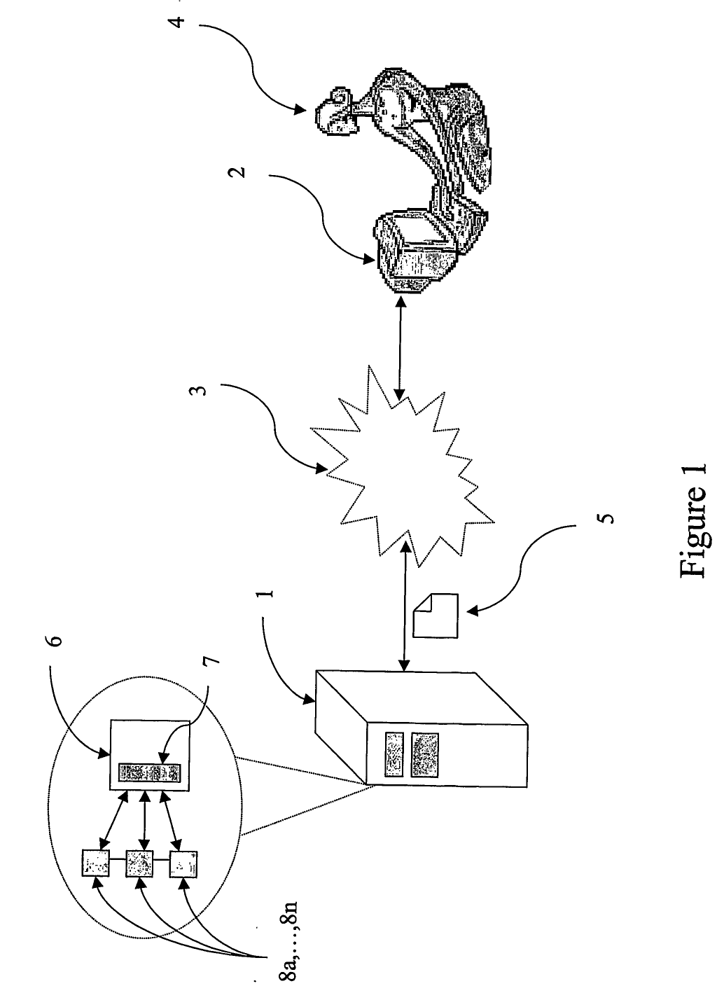

FIG. 1 is a schematic diagram of a system in accordance with an embodiment of the present invention, and

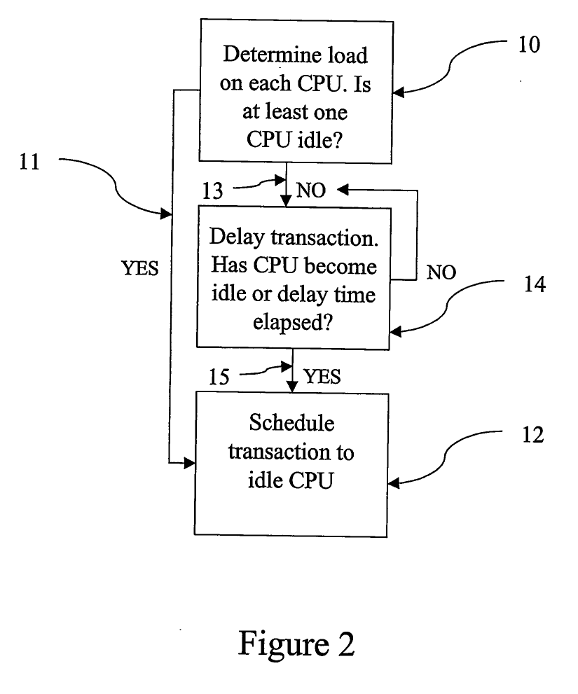

FIG. 2 is a flow chart depicting a method in accordance with an embodiment of the present invention.

### DESCRIPTION OF A PREFERRED EMBODIMENT

An embodiment of the present invention provides a method of improving the performance of transaction processing systems by delaying the processing of a transaction.

The performance of a transaction processing system is generally determined by the use of two principal performance characteristics or “statistics”. Firstly, performance of a transaction processing system may be measured by determining the number of transactions executed per unit time. Secondly, performance of a transaction processing system may also be measured by determining the time taken by the transaction processing system to “respond” to a transaction processing request. This measure is generally termed the “response time”.

The number of transactions executed per unit time is a measure of the overall throughput of the transaction processing system. Conversely, the response time is a measure of how responsive the system appears to an end user.

For example, a typical transaction processing system can process, on average, 100 transactions per second, and may serve, say, 1000 users. If each user makes a transaction request, on average, once every 10 seconds, then the average number of transactions executed per second would be 100. In the above example, if the transaction processing system has an average response time of 500 milliseconds, the time taken from when a user submits a transaction request until he or she receives a response indicating success or failure, would be 500 milliseconds.

In many circumstances, the more important statistic, when comparing methods for increasing the efficiency of a transaction processing system, is the number of transactions executed per unit time. It is desirable to maximise this value, as the more important parameter in a transaction processing system is the total system throughput, and not the response time for an individual transaction. It is only necessary to ensure that the response time remains within limits which are considered to be reasonable by an end user. For example, a user will not be able to discern whether the transaction processing system has a response time of, say, 20 milliseconds, or a response time of 100 milliseconds. Although one response time is five times longer than the other, a user will not be capable of discerning between the two values. In fact, the applicant has discovered that response times of up to 500 milliseconds are generally acceptable to an end user, in most situations. Therefore, a certain amount of response time may be sacrificed in order to increase the average number of transactions executed per unit time, and thereby increase overall throughput. One method for effecting this trade off is as follows.

In a multi-processor transaction processing system, the number of transactions executed at any given time will vary depending upon user requests. The number of requests made by multiple users within a given unit of time is generally referred to as the “load” of the system. At a certain time (for example, after office hours) the load on a transaction processing machine may be relatively light. At these times of light load, at least one CPU will generally be idle (ie no processes or threads are being executed on the CPU). In this situation, an incoming transaction is simply scheduled to a thread or process that executes on the idle CPU.

However, as the load on the transaction processing system increases, there may arise a situation where all CPU's are executing a thread or process. In the prior art, a new incoming transaction is immediately assigned to a CPU, and, once one time slice (say, 15 milliseconds) has elapsed, the currently running process is “unloaded” and the new process is loaded into the CPU, irrespective of whether the original thread or process has finished executing. Thus, a time and resource overhead is incurred when switching between these two processes, as outlined in the “Background of the Invention” of this document. In an embodiment of the present invention, rather than immediately assigning an incoming transaction to a CPU, the incoming transaction is held for a predetermined period of time, to determine whether a CPU will become free within the predetermined period of time. That is, the incoming transaction is put on hold for a number of time slices (for example, in a multi processor window system, it has generally been found that the transaction may be held for up to say, 15 time slices without unduly increasing response time). In some operating systems, the time slice is 15 milliseconds.

However, different operating systems may use different time slices, so the transaction may be held for more or less than 15 time slices, depending on the operating system, the computer hardware, or any other relevant consideration. If a CPU becomes free within this predetermined period of time, the incoming transaction will be scheduled to a thread or process on the CPU which has become available, where it can begin execution. As the previous transaction is allowed to finish execution, overhead is avoided, overhead which would have been incurred if the process was to switch a number of times. The end user does not notice any perceptible difference in the response time, but the overall throughput is increased since there are no performance penalty due to context switching and cache contention as occurs in the prior art.

If 15 time slices have elapsed, and there is still no available CPU, the transaction will then be scheduled to a thread or process that will execute alongside another transaction on the same CPU, as in the prior art.

Therefore, whilst a delay is introduced into the processing of a transaction request, the delay is small enough to be unnoticeable for practical purposes (that is, the end user will not notice the delay) and, in most situations, the delay will actually increase total throughput per unit of time.

The present invention may be implemented on an appropriate computing system, and, in one embodiment, is incorporated as a software module into an operating system. Referring to FIG. 1, there is shown a computing system comprising a server 1, the server 1 being arranged to receive input from an appropriate input device 2. In one embodiment, the input device 2 may be a remote terminal, connected through an appropriate network 3, such as the Internet or a proprietary intranet. A user 4 may submit a transaction request 5 to the computing system. The operating system 6, which resides on the server 1, has incorporated a software module 7 which determines the CPU load on all available CPU's 8a, . . . , 8n, and then makes a determination as to whether the transaction request 5 should be delayed for a defined period of time.

The CPU load may be determined by the use of any appropriate hardware monitor or software application. For example, the windows™ operating system contains an application termed “perfmon” which may be used to monitor a large number of performance characteristics, such as CPU load, disk access times, etc. Such an application may be used to determine the CPU load for the available CPU's 8a, . . . , 8n. It will be understood that the example given above is provided for illustrative purposes alone, and should not be construed as limiting.

An embodiment of the methodology employed to determine whether a transaction should be delayed for a defined period of time is shown in FIG. 2. On receipt of a transaction request 5, the software module 7 in the operating system 6 determines the load on each CPU 8a, . . . , 8n in the computing system (10). If a CPU has no load (11) (that is, the CPU is idle), then the transaction is immediately scheduled to the idle CPU (12). If all CPU's show a load (13), then the transaction request is delayed (14). If, during the delay, a CPU becomes available (15), then the transaction is immediately scheduled to the now idle CPU (12). If the defined period of time elapses and no CPU has become available, then the transaction request will be assigned to a CPU (i.e. placed in the transaction request queue for the CPU) (15).

It will be understood that the CPU may be polled at any appropriate time interval. Generally, the CPU is polled at every time slice, but this may vary according to particular requirements. Such variations are within the purview of a person skilled in the art.

Modifications and variations as would be apparent to a skilled addressee are deemed to be within the scope of the present invention.

1. A method of scheduling a transaction request to a central processing unit in a computing system, comprising the steps of,
for a transaction request, polling at least one central processing unit to determine the current load on the at least one central processing unit;
if the current load is below a predetermined threshold, allocating the transaction request to one of the at least one central processing unit; or
if the current load is above the predetermined threshold, delaying execution of the transaction request for a predetermined time delay, or until polling determines that the load is below the predetermined threshold.

2. A method in accordance with claim 1, comprising the further step of polling at defined time intervals to determine the system load.

3. A method in accordance with claim 2, wherein polling continues until the current load drops below the predetermined threshold, at which time the transaction request is allocated.

4. A method in accordance with claim 3, wherein the predetermined threshold is achieved when the at least one of a plurality of CPU's becomes idle.

5. A method in accordance with claim 4, wherein the predetermined time delay is chosen such that an end user cannot determine any perceptible change in response time.

6. A method in accordance with claim 5, wherein the predetermined time delay does not exceed 500 milliseconds.

7. A method in accordance with claim 5, wherein the predetermined time delay is in the order of one to fifteen time slice intervals.

8. A system for scheduling an incoming transaction to a central processing unit in a computing system, comprising:
polling means arranged to, on receipt of a transaction request, poll at least once central processing unit to obtain a value for the central processing unit load,
comparison means arranged to, if the current load is below a predetermined threshold, allocate the transaction request to one of the at least one central processing unit,
if the current load is above the predetermined threshold, delay execution of the transaction request for a predetermined time period.

9. A system in accordance with claim 8, wherein the polling means is arranged to continue to poll at defined time intervals to determine the system load.

10. A system in accordance with claim 9, comprising allocation means which is arranged to allocate the transaction when the comparison means determines that the current load has dropped below the predetermined threshold.

11. A system in accordance with claim 10, wherein the predetermined threshold is achieved when the at least one of a plurality of CPU's becomes idle.

12. A system in accordance with claim 11, wherein the predetermined time delay is chosen such that an end user cannot determine any perceptible change in response time.

13. A system in accordance with claim 12, wherein the predetermined time delay does not exceed 500 milliseconds.

14. A system in accordance with claim 12, wherein the predetermined time delay is in the order of one to fifteen time slice intervals.

15. A computer program arranged, when loaded on a computing system, to implement the method of any one of claims 1 to 6.

16. A computer readable medium providing a computer program in accordance with claim 15.
